(19) United States
(12) Patent Application Publication
(10) Pub. No.: US 2017/0184203 A1
(43) Pub. Date: Jun. 29, 2017

(54) Axle Seal

(71) Applicant: SEALS-IT, INC., Ellington, CT (US)

(72) Inventor: Stanley E. Matczak, Somers, CT (US)

(73) Assignee: SEALS-IT, INC., Ellington, CT (US)

(21) Appl. No.: 15/388,068

(22) Filed: Dec. 22, 2016

Related U.S. Application Data
(60) Provisional application No. 62/271,245, filed on Dec. 27, 2015.

(51) Int. Cl. F16J 15/3284; F16J 15/3232; F16J 15/3216

(52) U.S. Cl. CPC F16J 15/3284; F16J 15/3216; F16J 15/3232

(57) ABSTRACT

An axle seal is provided and includes a seal element having a seal element top, a seal element bottom, a seal element mounting lip which extends downwardly from the seal element bottom, and a seal element sleeve, wherein the seal element sleeve is securely and sealingly associated with the seal element mounting lip, and wherein the seal element includes a circumferential outer edge portion which extends outwardly from the seal element sleeve to form a circumferential lip around the seal element sleeve and wherein the seal element defines a seal element opening which communicates the seal element top with the seal element bottom.

### CROSS REFERENCE TO RELATED APPLICATIONS

This application is related to and claims benefit of priority of the filing date of U.S. Provisional Patent Application Ser. No. 62/271,245, filed Dec. 27, 2015, the content of which is incorporated herein by referenced in its entirety.

### FIELD OF THE INVENTION

The present invention relates generally to a seal and more particularly to a self-sealing axel seal for use with an automotive, marine and/or industrial axle.

### BACKGROUND OF THE INVENTION

Axle seals are well known in the art and are used on machinery that have a drive train that includes an axle that is connected to a gear box. Typically, the axle seal has two primary functions. The first function is to prevent the gear oil from escaping from the drive train. If the gear oil is allowed to leak from the drive train, the oil would contaminate other various parts of the machinery, such as brake shoes. Additionally, if too much oil is allowed to escape from the drive train, the drive train components, such as the transmission and/or differential, there may not be enough oil to lubricate the drive train components causing them to overheat. The second function is to prevent dirt and other contaminants from entering the drive train which could severely damage delicate gears and other components.

Unfortunately however, as current seal designs become worn they let a small amount of oil to escape and allow some contaminants to enter the drive train. This is undesirable because the drive train components can be subject to ware and overheating due to under-lubrication and because sand, dirt and other components can damage the drive train components.

### SUMMARY OF THE INVENTION

An axle seal is provided and includes a seal element having a seal element top, a seal element bottom, a seal element mounting lip which extends downwardly from the seal element bottom, and a seal element sleeve, wherein the seal element sleeve is securely and sealingly associated with the seal element mounting lip, and wherein the seal element includes a circumferential outer edge portion which extends outwardly from the seal element sleeve to form a circumferential lip around the seal element sleeve and wherein the seal element defines a seal element opening which communicates the seal element top with the seal element bottom.

An axle seal is provided and includes an axle seal body having a first seal body end and a second seal body end, wherein the axle seal body defines a seal body cavity, a first seal body end opening and second seal body end opening, wherein the first seal body end opening is communicated with the second seal body end opening via the seal body cavity. Additionally, the axle seal includes a seal element having a seal element top, a seal element bottom, a seal element mounting lip which extends downwardly from the seal element bottom, and a seal element sleeve, wherein the seal element sleeve is securely and sealingly associated with the seal element mounting lip, and wherein the seal element includes a circumferential outer edge portion which extends outwardly from the seal element sleeve to form a circumferential lip around the seal element sleeve and wherein the seal element defines a seal element opening which communicates the seal element top with the seal element bottom, and wherein the seal element is securingly and sealingly associated with the axle seal body to cover the first seal body end opening.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1A is a front view of an end seal for axle, in accordance with one embodiment of the invention.

FIG. 1B is a rear view of the end seal of FIG. 1A.

FIG. 1C is a side view of the end seal of FIG. 1A.

FIG. 1D is a side view of the end seal of FIG. 1A.

FIG. 1E is a side sectional view of the end seal of FIG. 1A.

FIG. 1F is a side sectional view of the axle seal of FIG. 1A illustrating one size the end seal in accordance with one embodiment of the invention.

FIG. 1G is a side view of the end seal of FIG. 1A and an axle seal.

FIG. 1H is a side view of the end seal of FIG. 1A being installed onto one end of the axle seal of FIG. 1G.

FIG. 1I is a side view of the end seal of FIG. 1A installed onto one end of the axle seal of FIG. 1G.

FIG. 2A is a front view of an axle seal, in accordance with another embodiment of the invention.

FIG. 2B is a front side view of the axle seal of FIG. 2A having an end seal installed on only one end of the axle seal.

FIG. 2C is a side view of the axle seal of FIG. 2A having a end seal installed on only one end of the axle seal.

FIG. 2D is a front view of the axle seal of FIG. 2A having a end seal installed on only one end of the axle seal.

FIG. 2E is a side view of the axle seal of FIG. 2A having a end seal installed on both ends of the axle seal.

FIG. 2F is a front side isometric view of the axle seal of FIG. 2A having a end seal installed on both ends of the axle seal.

FIG. 2G is a side view of the axle seal of FIG. 2A having an end seal installed on both ends of the axle seal.

FIG. 3A is a side sectional view of an end seal located within an axle housing, in accordance with one embodiment of the invention.

FIG. 3B is a side sectional view of the end seal and the axle housing of FIG. 3A.

FIG. 3C is a side sectional view of the end seal and the axle housing of FIG. 3A.

FIG. 3D is a side sectional view of the end seal and the axle housing of FIG. 3A with the end seal associated with an axle and located within the axle housing.

### DETAILED DESCRIPTION OF THE INVENTION

In accordance with the present invention, an axle seal for use with automotive, marine and/or industrial machinery having an axle is provided and discussed herein with regards to an axle for an automobile. It should be appreciated that although the axle seal of the present invention is discussed herein with regards to an automobile axle, the axle seal of the present invention may be used with any type of axle suitable to the desired end purpose.

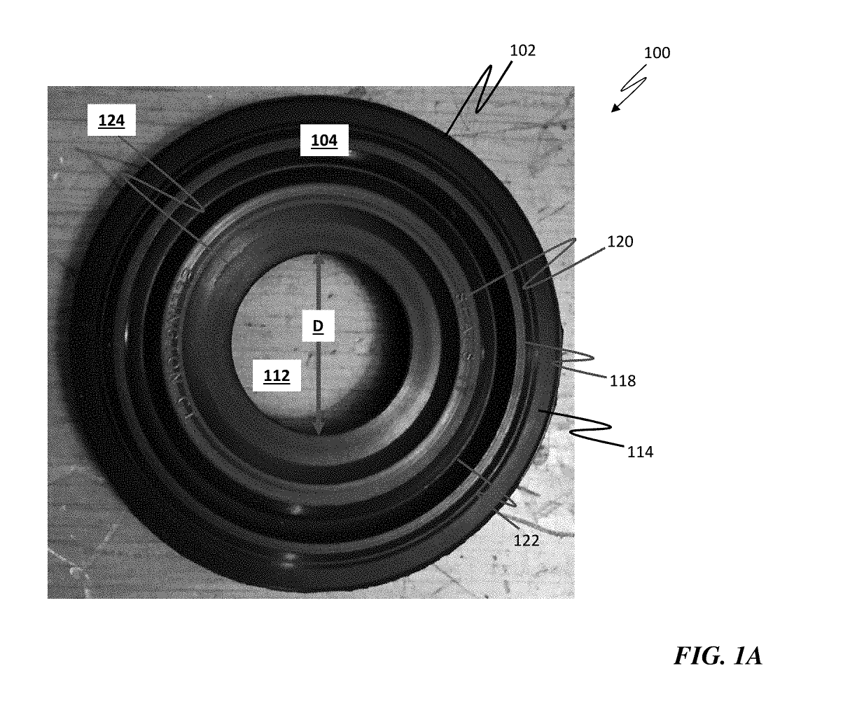

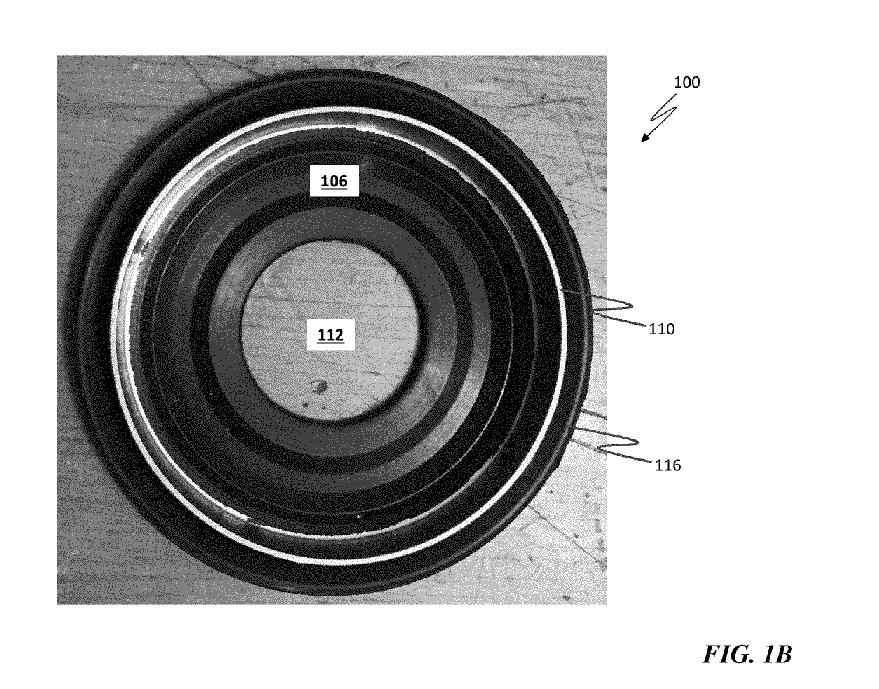

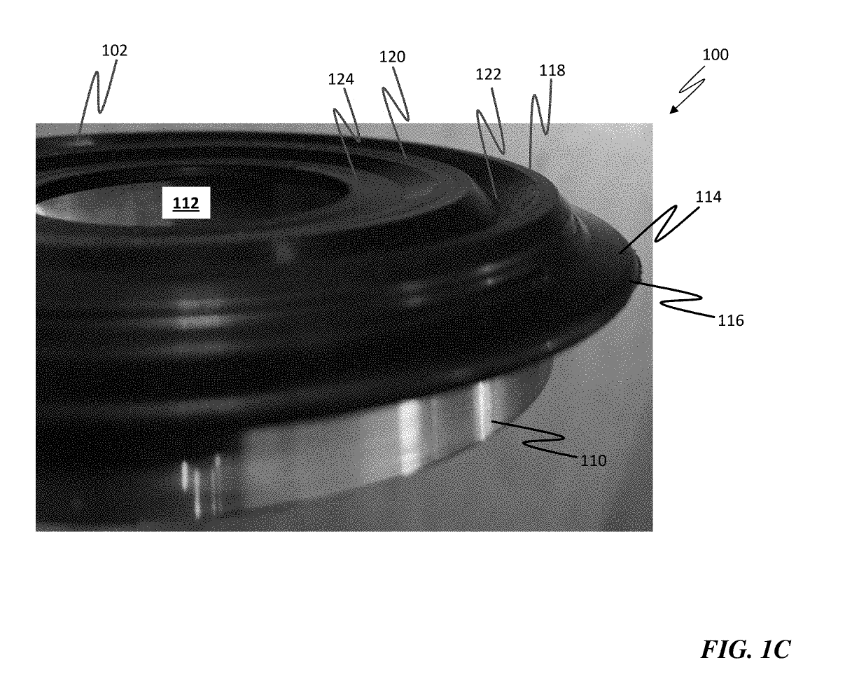

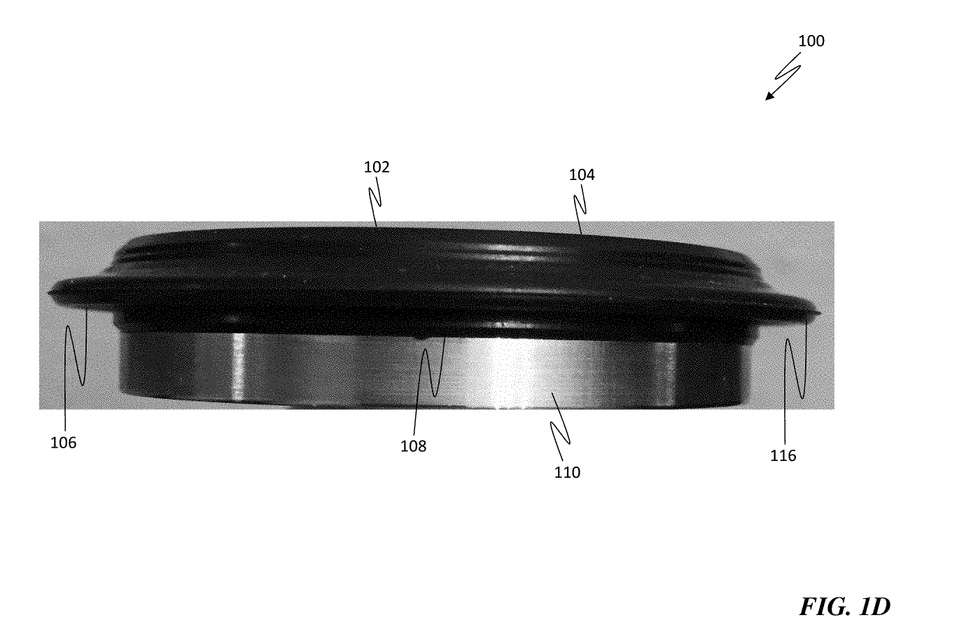

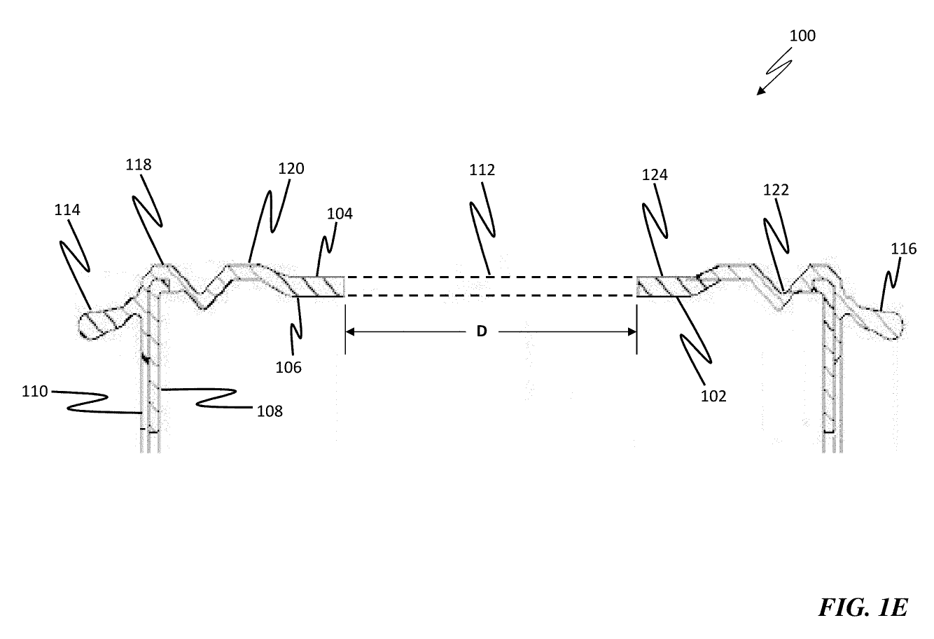

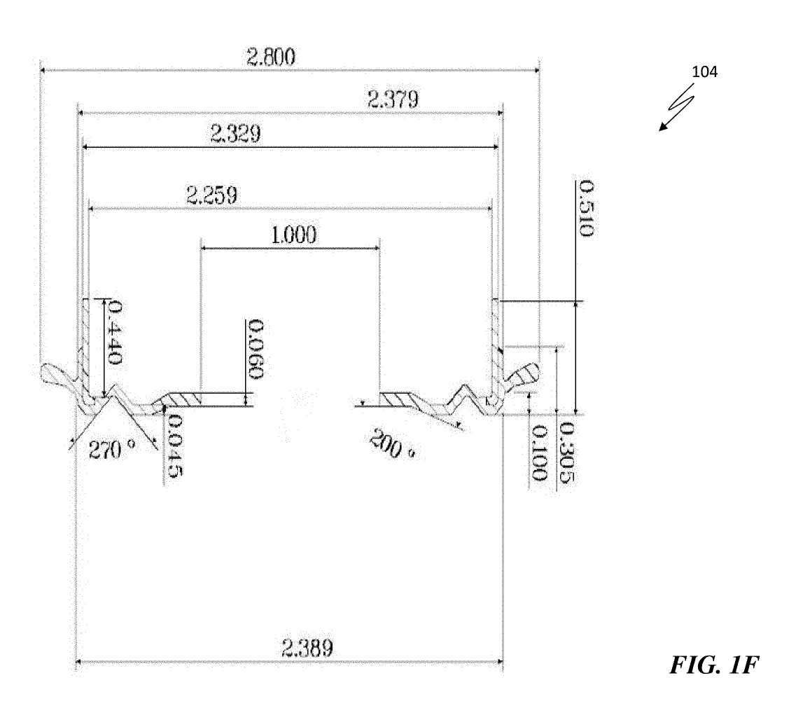

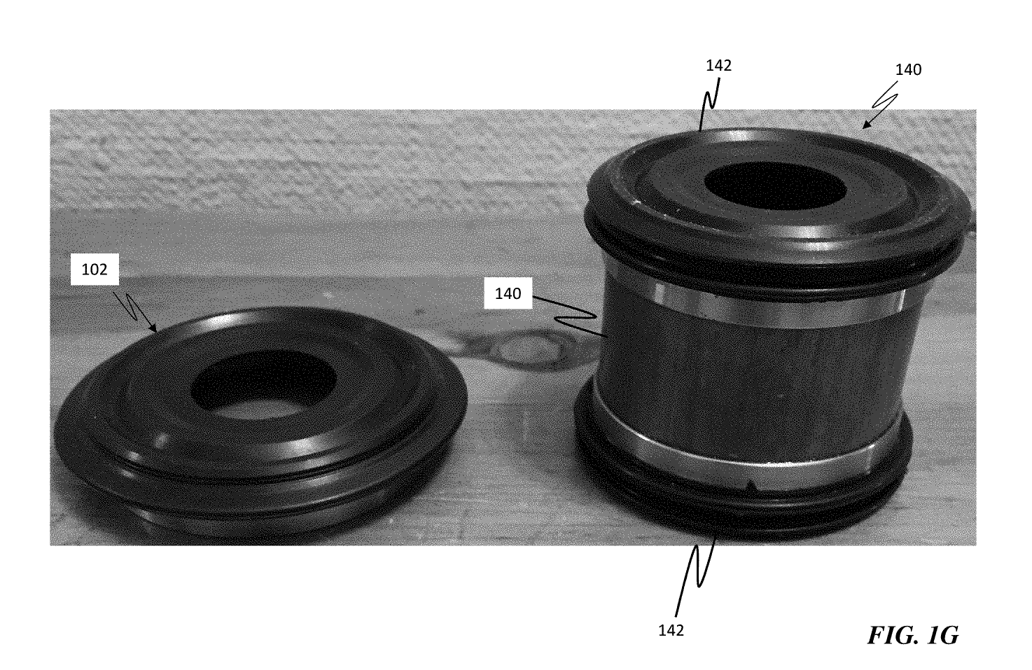

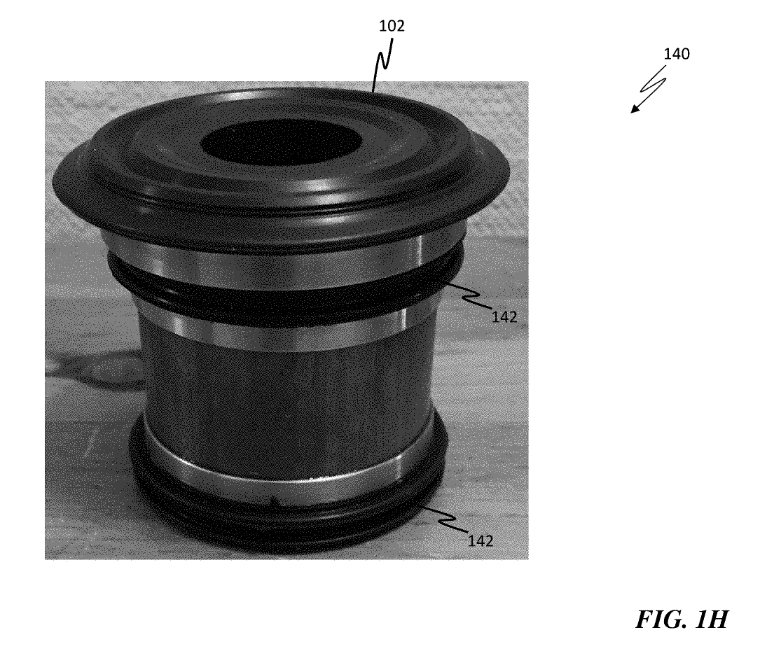

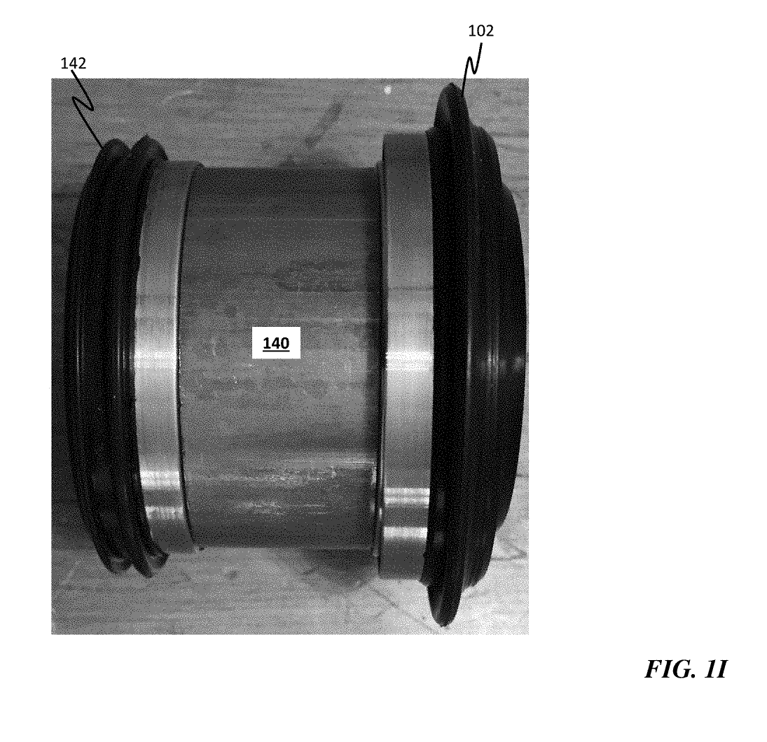

Referring to FIG. 1A to FIG. 1F, an end seal 100 is shown in accordance with one embodiment of the invention and includes a seal element 102 having a seal element top 104, a seal element bottom 106 and a seal element mounting lip 108, wherein the seal element mounting lip 108 extends downwardly from the seal element bottom 106. The seal element 102 further includes a seal element sleeve 110 which is securely associated with the seal element 102 via the seal element mounting lip 108. In one embodiment, the seal element sleeve 102 is attached to, fused to or otherwise bonded to the seal element mounting lip 108 via an adhesive bonding, a chemical bonding, a mechanical means of attachment and/or any attachment, fusing and/or bonding method as desired and known in the art and suitable to the desired end purpose.

The seal element 102 defines an axle opening 112 having an axle opening diameter D, wherein the axle opening 112 is located in and/or proximate to the center of the seal element 102. The seal element 102 includes a circumferential outer edge 114 which extends outwardly from the seal element sleeve 110 to form a circumferential lip 116 around seal element sleeve 110. It should be appreciated that in at least one embodiment the circumferential outer edge 114 may be substantially flat and in other embodiments the circumferential outer edge 114 may be angle downwardly at an angle β ranging between about 1 degree and about 20 degrees, as desired. The seal element 102 further includes a first raised portion 118 and a second raised portion 120 separated by a first valley portion 122, wherein the first raised portion 118 and second raised portion 120 are located inward from the circumferential outer edge 114 toward the center of the seal element 102. Additionally, the seal element 102 includes a substantially flat center portion 124 located between the second raised portion 120 and the axle opening 112. It should be appreciated that the transition between the first and second raised portions 118, 120 and the first valley portion 122 and the center portion 124 and the second raised portion 120 are angled to provide a gradual transition. The axle opening 112 is sized to be smaller in diameter than an axle 134 passing there-through by approximately 20% (range of 10% to 40%) and the seal element 102 is preferably constructed from a material that is resilient to sealingly interact act with an axle 134 when the axle 134 is located within the axle opening 112. For example, the seal element 102 may be constructed from a polymer material, such as nitrile, neoprene, plastic, rubber and/or any other material suitable to the desired end purpose. FIG. 1F illustrates one size of a seal element 102 in accordance with one embodiment of the invention, wherein the dimensions shown are in inches.

Referring to FIG. 1G to FIG. 1I, the seal element 102 is shown being implemented in retrofit fashion with an axle seal body 140 having existing end seals 142 located on either end of the axle seal body 140. In this embodiment, the seal element 102 is slid over the end seals 142 on either end of the axle seal body 140. When the seal element 102 is located over the end seals 142, the top portion of the end seals 142 are in contact with the seal element bottom 106 of the seal element 102 thus forming a seal between the end seal 142 and the seal element bottom 106 of the seal element 102. Additionally, the side portion of the end seal 142 is in contact with the inside surface of the seal element sleeve 110 to form a seal between the side portion of the end seal 142 and the seal element sleeve 110. It should be appreciated that the axle seal body 140 and the seal element sleeve 110 may be constructed from any rigid material desired that is suitable to the desired end result, such as metal, plastic, composite and/or any combination thereof. It should be further appreciated that the seal element 102 may be securely and sealingly associated with the axle seal body 140 via any method and/or device suitable to the desired end purpose. For example, in one embodiment, the diameter of the seal element 102 and the axle seal body 140 may be similarly sized such that the seal element 102 and the axle seal body 140 may be securely associated via friction and/or a “press fit” configuration (a sealing material may or may not be located between the seal element 102 and the axle seal body 140 as desired). In another embodiment, an adhesive (and/or) a clamp may be used to securely and sealingly associate the seal element 102 and the axle seal body 140.

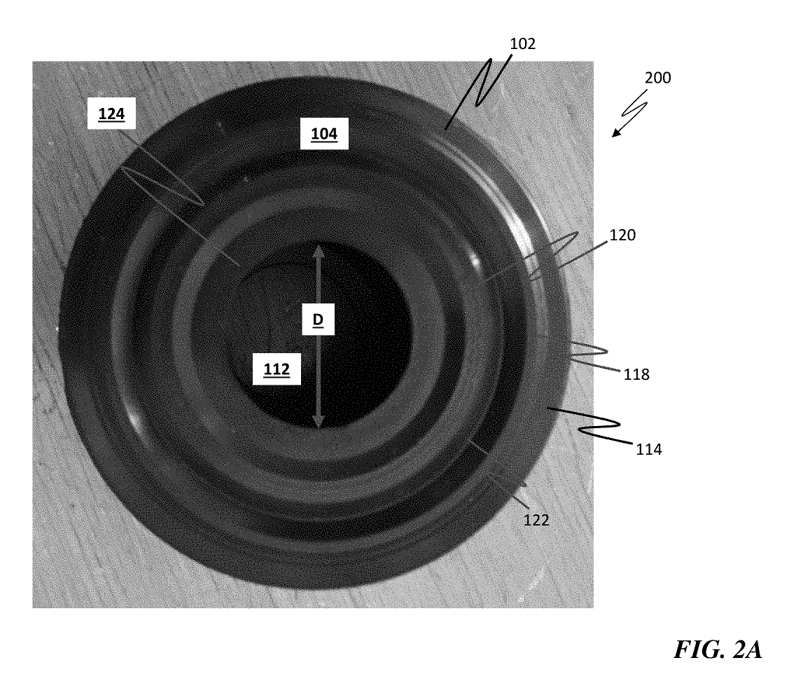

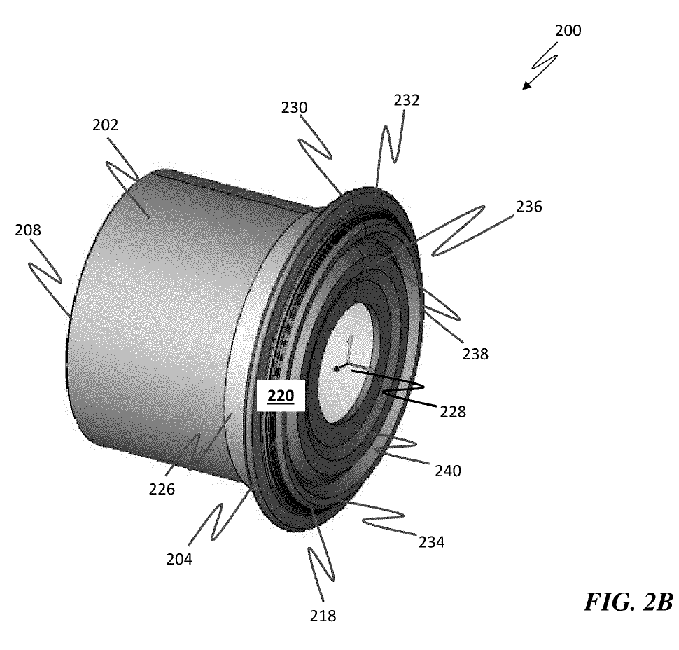

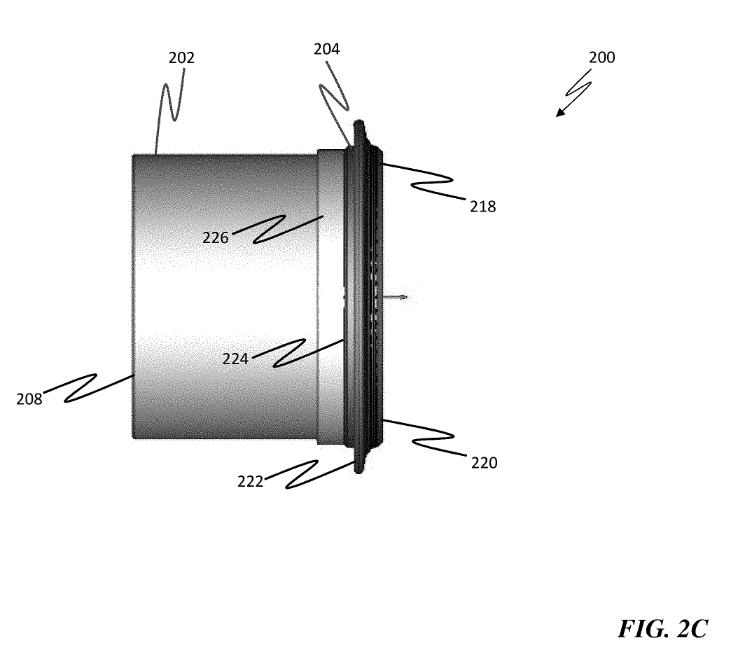

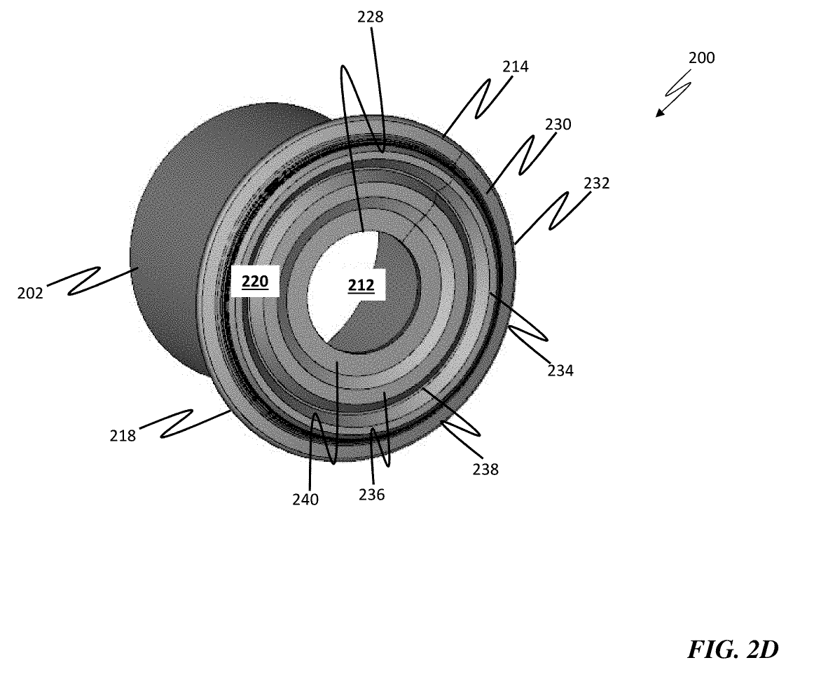

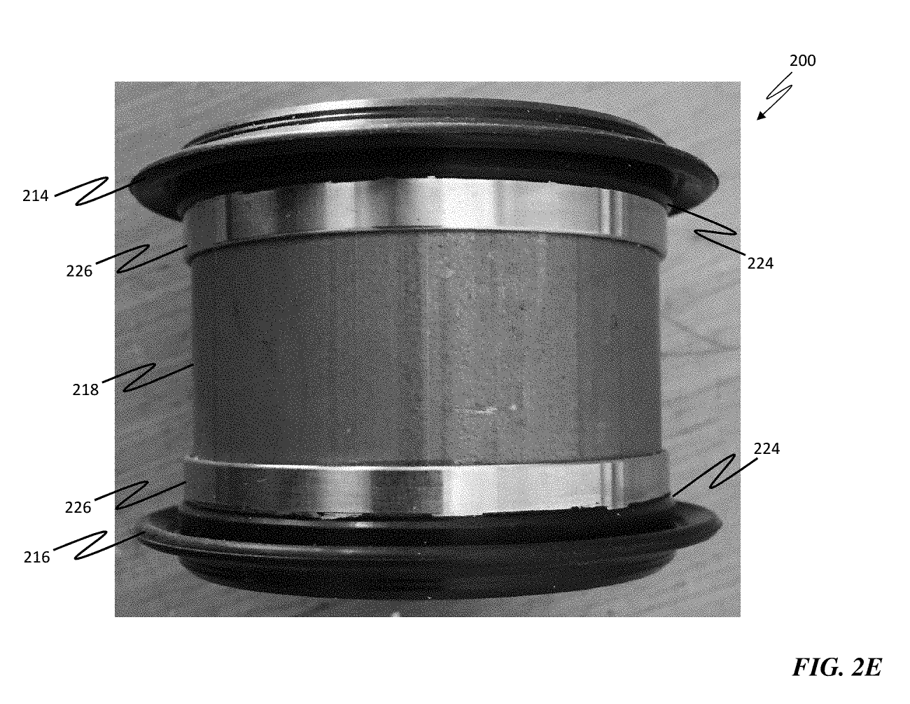

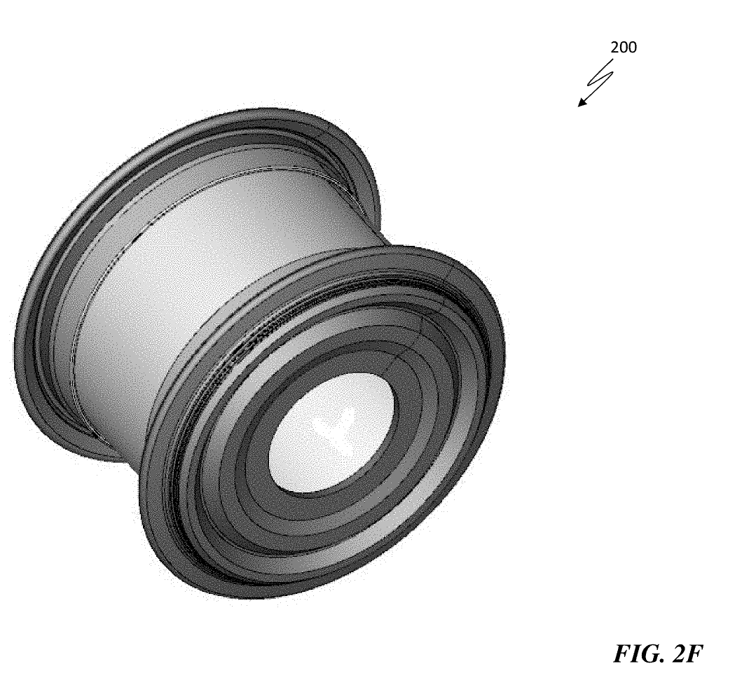

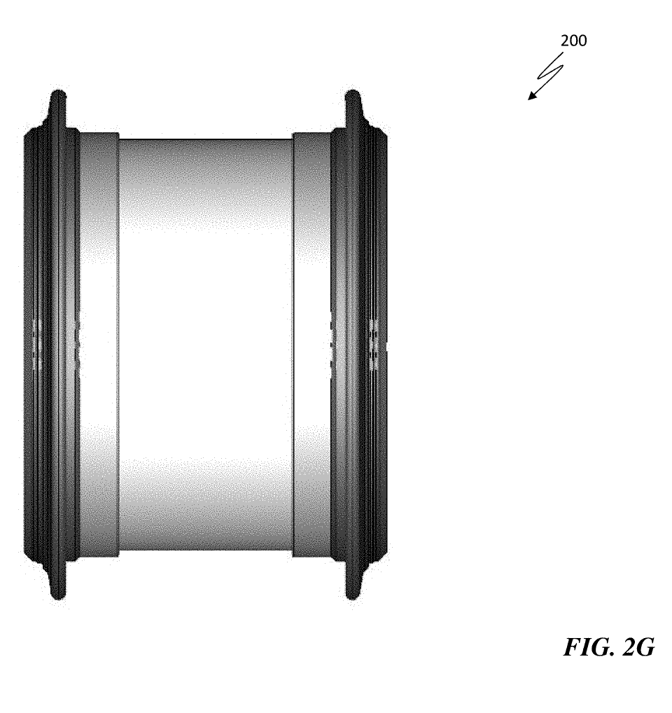

Referring to FIG. 2A to FIG. 2G, an axle seal 200 is shown in accordance with another embodiment of the invention and includes a substantially rigid seal body 202, wherein the seal body 202 includes a first seal body end 204 defining a first seal body end opening and a second seal body end 208 defining a second seal body end opening. The seal body 202 is substantially cylindrical in shape and further defines a seal cavity 212, wherein the seal cavity 212 communicates the first seal body end opening with the second seal body end opening. The axle seal 200 further includes a first end seal 214 securely associated with the first seal body end 204 and a second end seal 216 securely associated with the second seal body end 208. Both the first end seal 214 and the second seal end 216 include a seal element 218 having a seal element top 220, a seal element bottom 222 and a seal element mounting lip 224, wherein the seal element mounting lip 224 extends downwardly from the seal element bottom 222. The seal element 218 further includes a seal element sleeve 226 which is securely associated with the seal element 218 via the seal element mounting lip 224. In one embodiment, the seal element sleeve 226 is attached to, fused to or otherwise bonded to the seal element mounting lip 224 via an adhesive bonding, a chemical bonding, a mechanical means of attachment and/or any attachment, fusing and/or bonding method as desired and known in the art and suitable to the desired end purpose. The first end seal 214 and second end seal 216 are securely associated with the first seal body end 204 and second seal body end 208, respectively, via the seal element sleeve 226 which is securely associated with the seal body 202 to cover the first and second seal body end opening, respectively.

The seal element 218 defines an axle opening 228 having an axle opening diameter D, wherein the axle opening 228 is located in and/or proximate to the center of the seal element 218. The seal element 218 includes a substantially flat circumferential outer edge 230 which extends outwardly from the first and second seal body end 204, 208 to form a circumferential lip 232 around the first and second seal body end 204, 208. The seal element 218 further includes a first raised portion 234 and a second raised portion 236 separated by a first valley portion 238, wherein the first raised portion 234 and second raised portion 236 are located inward from the circumferential outer edge 230 toward the center of the seal element 218. Additionally, the seal element 218 includes a substantially flat center portion 240 located between the second raised portion 236 and the axle opening 228. It should be appreciated that the transition between the first and second raised portions 234, 236 and the first valley portion 238 and the center portion 240 and the second raised portion 236 are angled to provide a gradual transition.

The axle opening 220 is sized to be smaller in diameter than an axle 234 passing therethrough by approximately 20% (range of 10% to 40%) and the seal element 218 is preferably constructed from a material that is resilient to sealingly interact act with the axle 234 when the axle 234 is located within the axle opening 220. For example, the seal element 218 may be constructed from a polymer material, such as nitrile, neoprene, plastic, rubber and/or any other material suitable to the desired end purpose. Moreover, the seal cavity 212 defined between first end seal 214 and second end seal 216 may have a lubricant deposited therein to further reduce rotational friction and to improve seal integrity, wherein the seal cavity 212 acts as a reservoir for lubricant. Because the axle opening 220 is smaller than the axle 234 that is contained therein, the material around the axle opening 220 compressingly contacts the axle 234 creating a seal between the seal element 218 and the axle 234 which causes the lubricant to be kept within the seal cavity 212 to provide constant lubricant for the axle 234.

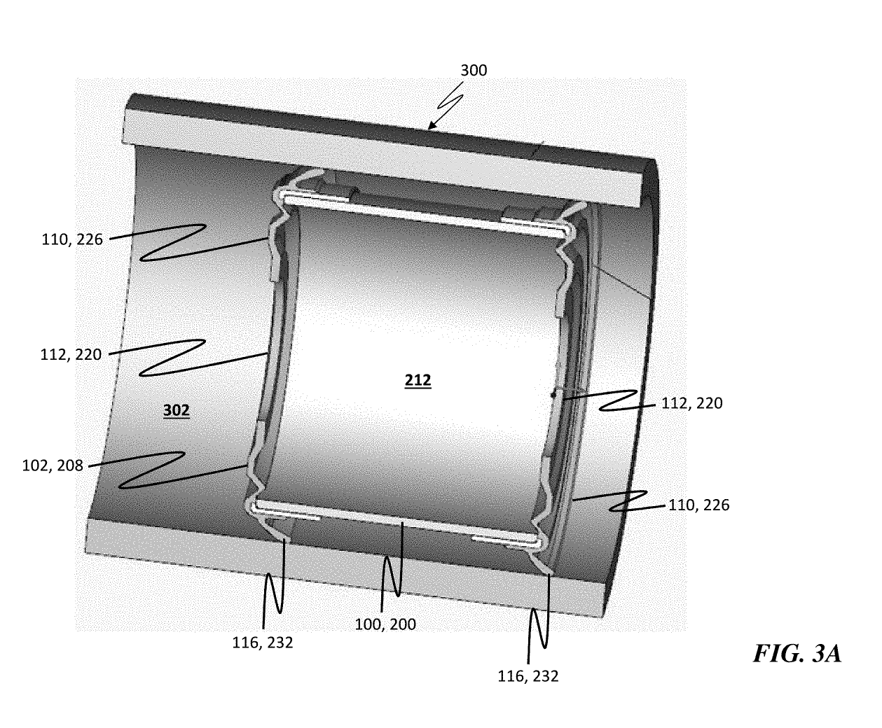

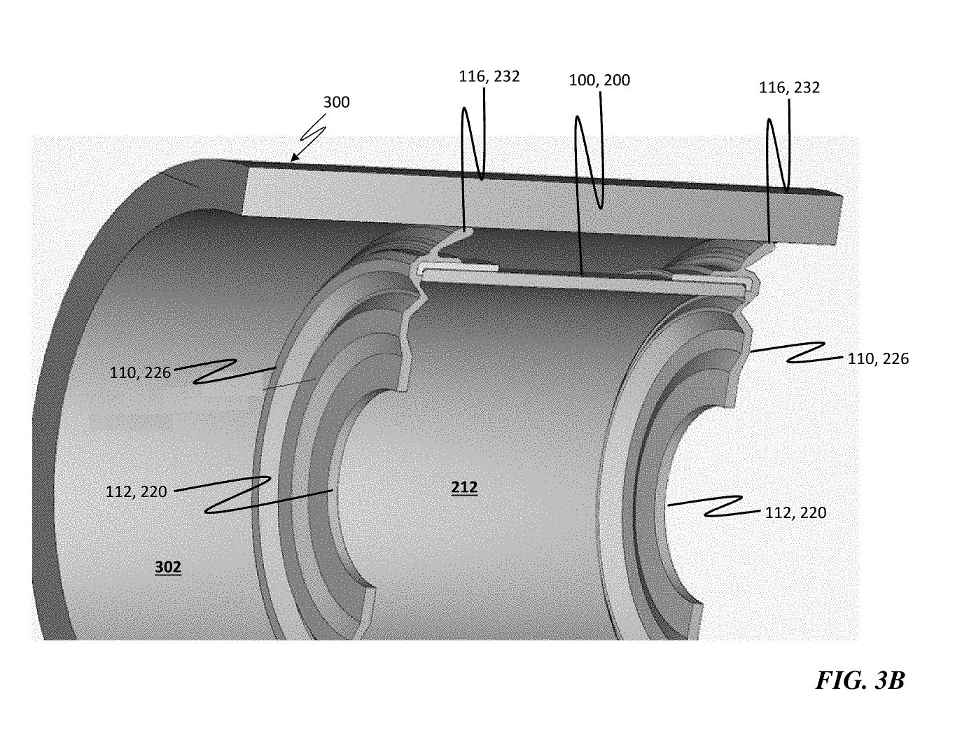

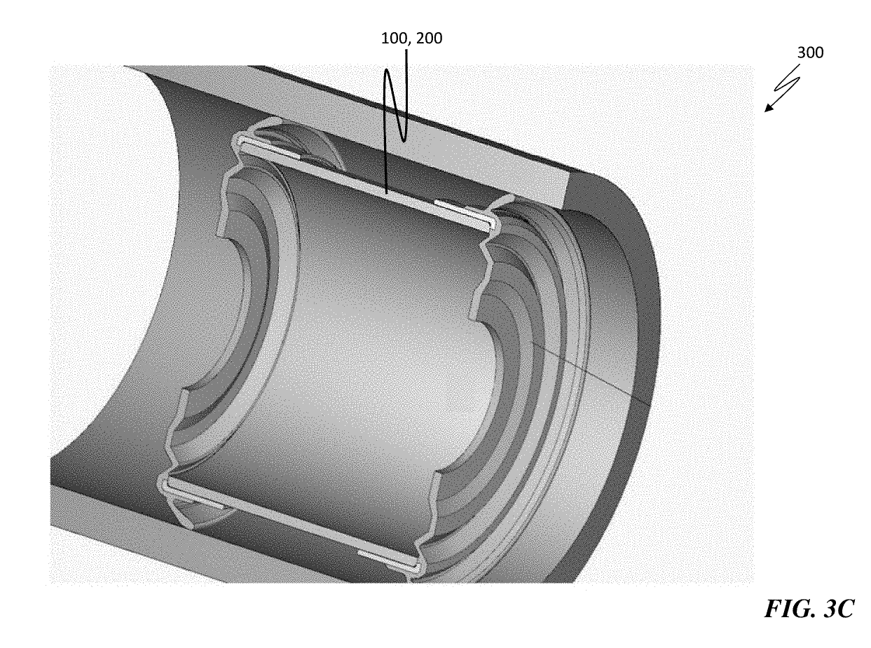

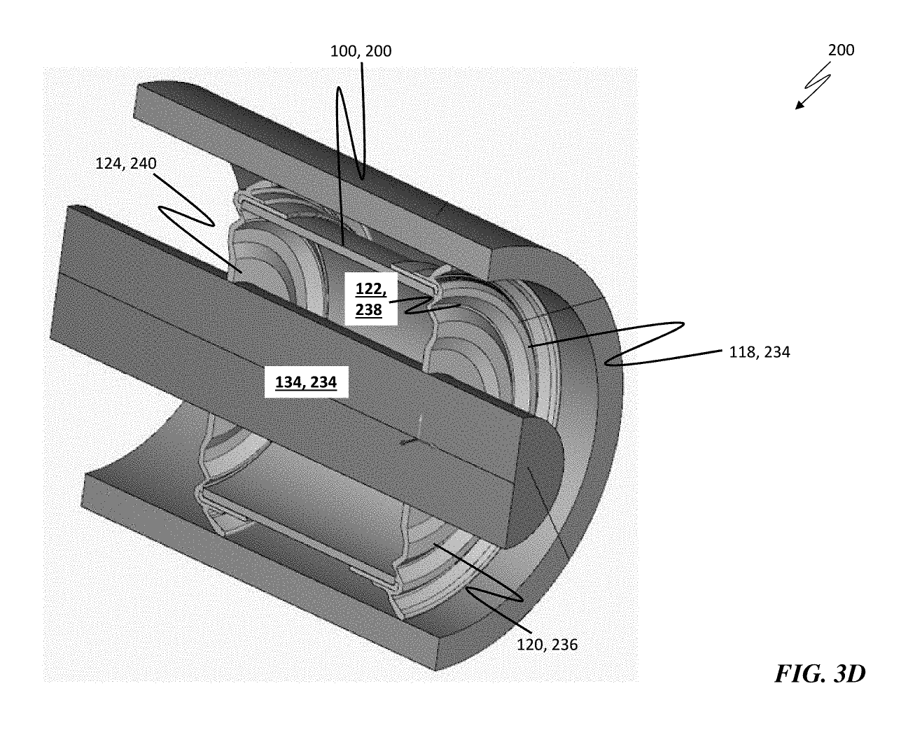

Referring to FIG. 3A, FIG. 3B and FIG. 3C, when the axle seal 100, 200 is located within an axle housing 300, the circumferential lip 116, 232 of the seal element sleeve 110, 226 is compressed against the inner wall 302 of the axle housing (tube) 300. This advantageously forms a seal between the circumferential lip 116, 232 of the seal element sleeve 110, 226 and the inner wall 302 of the axle housing 300. Upon insertion of the axle seal 100, 200 into the axle housing 300, the axle seal 100, 200 will be securely held inside the axle housing (tube) 300. This is due to the friction between the circumferential lip 116, 232 of the seal element sleeve 110, 226 and the inner wall 302 of the axle housing 300 (sort of like a “finger trap” device). This locking method is what holds the axle seal 100, 200 inside of the axle housing (tube) 300 thus preventing and/or minimizing leakage of lubricant. Referring to FIG. 3D, when the axle seal 100, 200 is associated with the axle 134, 234 such that the axle is located within the axle opening 112, 220, the material of the center portion 124, 240 of the seal element 102, 218 that surrounds the axle opening 112, 220 will heat up (to approximately 270°-300°) as the axle 134, 234 spins upon initial operation. This advantageously causes the material of the center portion 124, 240 that contacts the axle 134, 234 to become harder and more rigid (less pliable), thus preventing and/or minimizing leakage of lubricant from the lubricant reservoir within the seal cavity 212. It should be appreciated that the lubricant within the reservoir within the seal cavity 212 may be any lubricant desired suitable to the desired end purpose, such as a low temperature melt grease. Additionally, the material of the seal element 102, 218 that includes the first raised portion 118, 234, the second raised portion 120, 236 and the first valley portion 122, 238 does not heat up as much as the center portion 124, 240 and remains pliable allowing the axle seal 100, 200 to flex during operation of the axle 134, 234.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Moreover, it is contemplated that elements of one embodiment may be combined with elements of other embodiments as desired. Therefore, it is intended that the invention not be limited to a particular embodiment disclosed herein as the best mode contemplated for carrying out this invention, but that the invention will include all embodiments (individually and/or combined) falling within the scope of the appended claims and/or information. Moreover, unless specifically stated any use of the terms first, second, etc. do not denote any order or importance, but rather the terms first, second, etc. are used to distinguish one element from another.

I claim:

1. An axle seal, comprising:
a seal element having
a seal element top,
a seal element bottom,
a seal element mounting lip which extends downwardly from the seal element bottom, and
a seal element sleeve, wherein the seal element sleeve is securely and sealingly associated with the seal element mounting lip, and
wherein the seal element includes a circumferential outer edge portion which extends outwardly from the seal element sleeve to form a circumferential lip around the seal element sleeve and wherein the seal element defines a seal element opening which communicates the seal element top with the seal element bottom.

2. The axle seal of claim 1, wherein the seal element includes a substantially flat center portion, a first raised portion and a second raised portion separated by a first valley portion, wherein the first raised portion and second raised portion are located inward from the circumferential outer edge toward the center portion.

3. The axle seal of claim 2, wherein the first raised portion and second raised portion include a side wall which extends up from the first valley portion, wherein the side wall is angled to provide a gradual transition between the first and second raised portions and the first valley portion.

4. The axle seal of claim 1, wherein the seal element opening is configured to sealingly associate with an axle having an axle diameter and wherein the seal element opening includes a opening diameter D, wherein the opening diameter D is sized to be between about 10% to about 40% smaller than the axle diameter.

5. The axle seal of claim 1, wherein the seal element opening is configured to sealingly associate with an axle having an axle diameter and wherein the seal element opening includes a opening diameter D, wherein the opening diameter D is sized to be about 20% smaller than the axle diameter.

6. The axle seal of claim 1, wherein at least a portion of the seal element is constructed from a polymer material.

7. The axle seal of claim 6, wherein the polymer material includes at least one of nitrile, neoprene, plastic, rubber or any combination thereof.

8. The axle seal of claim 1, wherein the seal element is constructed from a resilient and flexible material.

9. The axle seal of claim 1, wherein the circumferential outer edge portion is angled downwardly at an angle β ranging between about 1 degree and about 20 degrees.

10. An axle seal, comprising:
an axle seal body having a first seal body end and a second seal body end, wherein the axle seal body defines a seal body cavity, a first seal body end opening and second seal body end opening, wherein the first seal body end opening is communicated with the second seal body end opening via the seal body cavity; and
a seal element having
a seal element top,
a seal element bottom,
a seal element mounting lip which extends downwardly from the seal element bottom, and
a seal element sleeve, wherein the seal element sleeve is securely and sealingly associated with the seal element mounting lip, and
wherein the seal element includes a circumferential outer edge portion which extends outwardly from the seal element sleeve to form a circumferential lip around the seal element sleeve and wherein the seal element defines a seal element opening which communicates the seal element top with the seal element bottom, and
wherein the seal element is securingly and sealingly associated with the axle seal body to cover the first seal body end opening.

11. The axle seal of claim 10, wherein the seal element includes a substantially flat center portion, a first raised portion and a second raised portion separated by a first valley portion, wherein the first raised portion and second raised portion are located inward from the circumferential outer edge toward the center portion.

12. The axle seal of claim 11, wherein the first raised portion and second raised portion include a side wall which extends up from the first valley portion, wherein the side wall is angled to provide a gradual transition between the first and second raised portions and the first valley portion.

13. The axle seal of claim 10, wherein the seal element opening is configured to sealingly associate with an axle having an axle diameter and wherein the seal element opening includes a opening diameter D, wherein the opening diameter D is sized to be between about 10% to about 40% smaller than the axle diameter.

14. The axle seal of claim 10, wherein the seal element opening is configured to sealingly associate with an axle having an axle diameter and wherein the seal element opening includes a opening diameter D, wherein the opening diameter D is sized to be about 20% smaller than the axle diameter.

15. The axle seal of claim 10, wherein the first seat least a portion of the seal element is constructed from a polymer material.

16. The axle seal of claim 15, wherein the polymer material includes at least one of nitrile, neoprene, plastic, rubber or any combination thereof.

17. The axle seal of claim 10, wherein the seal element is constructed from a resilient and flexible material.

18. The axle seal of claim 10, wherein the circumferential outer edge portion is angled downwardly at an angle β ranging between about 1 degree and about 20 degrees.

19. The axle seal of claim 10, further comprising a second seal element, wherein the second seal element is securingly and sealingly associated with the axle seal body to cover the second seal body end opening.

20. The axle seal of claim 19, wherein the seal element opening of the seal element is communicated with the first seal body end opening and wherein the seal element opening of the second seal element is communicated with the second seal body end opening.
